(19) United States
(12) Patent Application Publication
(10) Pub. No.: US 2012/0173194 A1
(43) Pub. Date: Jul. 5, 2012

(54) COMPUTING DEVICE AND METHOD OF COMPENSATING CENTER POSITION OF MECHANICAL ARMS

(75) Inventors: HSIEN-CHUAN LIANG, Tu-Cheng (TW); SHEN-CHUN LI, Tu-Cheng (TW); SHOU-KUO HSU, Tu-Cheng (TW)

(73) Assignee: HON HAI PRECISION INDUSTRY CO., LTD., Tu-Cheng (TW)

(21) Appl. No.: 13/284,992

(22) Filed: Oct. 31, 2011

(30) Foreign Application Priority Data
Dec. 30, 2010 (TW) 099146844

(51) Int. Cl. G06F 15/00

(52) U.S. Cl. 702/151

(57) ABSTRACT

In a method of compensating the center position of a mechanical arm which has a first probe, a second probe, and a platform, a first test point and a second test point are selected on an electronic product and coordinates of the two points are acquired. A distance R between the first probe and the mechanical arm is received, and an angle θ between the platform and a line formed according to the two points is computed to obtain compensated coordinates of the mechanical arm. The mechanical arm moves to the location of the compensated coordinates, and thus locating the first probe and the second probe respectively at the first test point and the second test point.

### BACKGROUND

1. Technical Field

Embodiments of the present disclosure relate to devices and methods of measuring electronic products, and more particularly to a computing device and a method of compensating the center position of a mechanical arm of a measuring machine when the measuring machine measures an electronic product.

2. Description of Related Art

A mechanical arm is a robotic, usually programmable, with similar functions to a human arm. Links of the mechanical arm are connected by joints allowing either rotational motion or translational displacement.

Many mechanical arms are positioned on a measuring machine to automatically measure objects, such as to automatically measure electronic products. During the measuring process, the mechanical arm moves to a test point of an electronic product, so that a probe positioned at the end of the central axle of the mechanical arm (the center position of the mechanical arm, hereinafter) touches the test point to obtain measuring values, such as current, or resistance of the test point. It may be understood that, if there is only one probe and the probe is positioned at the end of the center position of the mechanical arm, it is easy for the mechanical arm to locate the test point. However, sometimes, two or more probes are needed to measure an electronic product, such as to measure a voltage of an electronic component of the electronic product. The two or more probes may not be positioned at the end of the center position of the mechanical arm, like the example shown in FIG. 1. Thus, it is hard for the mechanical arm to locate test points accurately.

### BRIEF DESCRIPTION OF THE DRAWINGS

FIG. 1 is an example of a positional relationship of two probes and the center position of a mechanical arm.

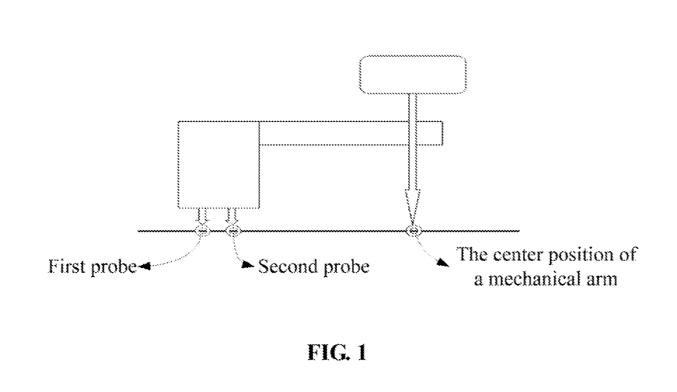

FIG. 2 is a block diagram of one embodiment of a computing device comprising a center position compensation system.

FIG. 3 is a block diagram of one embodiment of function modules of the center position compensation system of FIG. 2.

FIG. 4 is a flowchart of one embodiment of a method of compensating a center position of a mechanical arm.

FIG. 5 is an example of a compensated center position of a mechanical arm.

### DETAILED DESCRIPTION

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

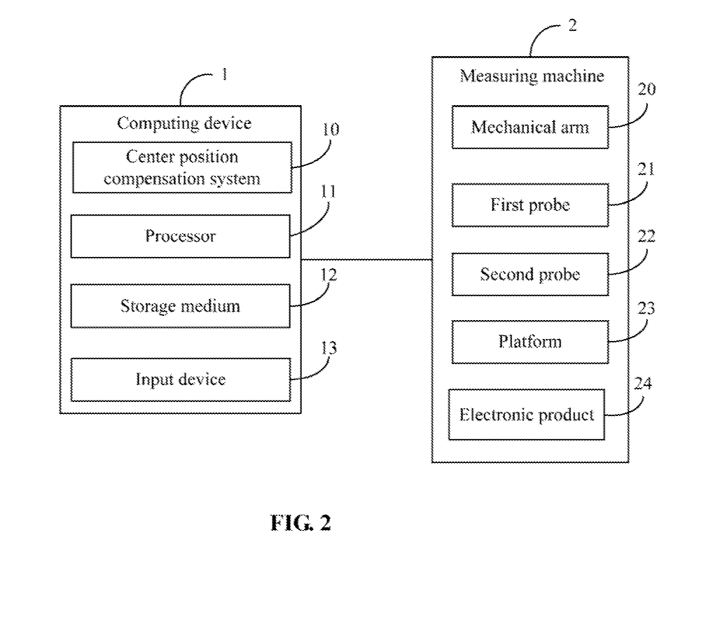

FIG. 2 is a block diagram of one embodiment of a computing device comprising a center position compensation system 10. In the embodiment, the computing device 1 further includes at least one processor 11, a non-transitory storage medium (hereinafter, storage medium for short) 12, and an input device 13. Depending on the embodiment, the storage medium 12 may be a hard disk drive, a compact disc, a digital video disc, a tape drive or other suitable storage medium. The input device 13 may be, such as, a keyboard, a touch screen, and a voice recognition device.

The computing device 1 connects with a measuring machine 2. The measuring machine 2 includes a mechanical arm 20, a first probe 21, a second probe 22, a platform 23. An electronic product 24 which includes a plurality of electronic components may be placed on the platform 23 of the measuring machine 2. The first probe 21 and the second probe 22 are positioned on the mechanical arm 20. The first probe 21 and the second probe 22 can respectively be located at a first test point and a second test point on the electronic components of the electronic product 24 with the movement of the mechanical arm 20.

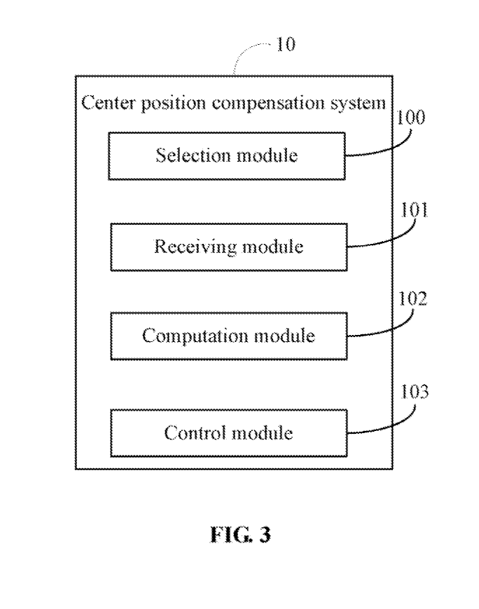

The center compensation system 10 includes a number of function modules (depicted in FIG. 3). The function modules may comprise computerized code in the form of one or more programs that are stored in the storage medium 12. The computerized code includes instructions that are executed by the at least one processor 11, to compute coordinates of the center position of the mechanic arm 20 when measuring test points on the electronic product 24, for the first probe 21 and the second probe 22 accurately locating the test points.

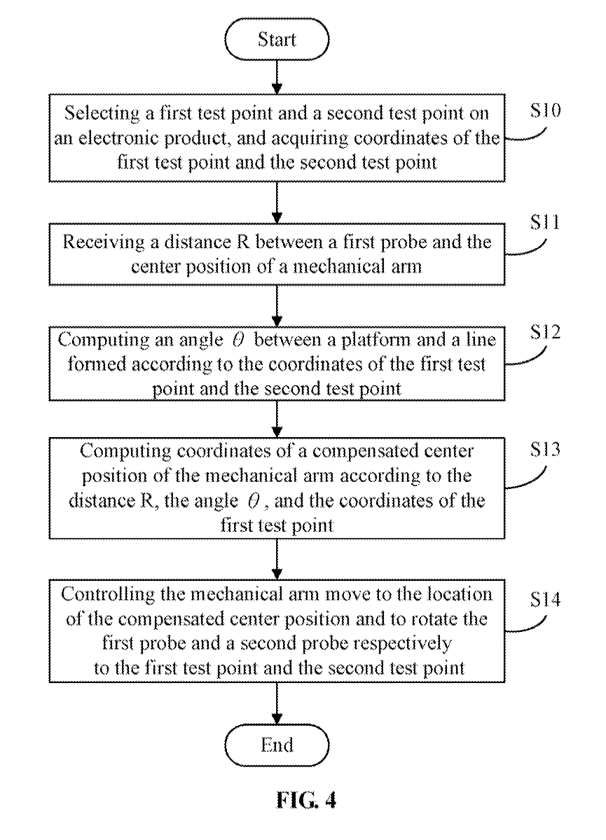

FIG. 3 is a block diagram of one embodiment of function modules of the center position compensation system 10 of FIG. 2. In one embodiment, the center position compensation system 10 may include a selection module 100, a receiving module 101, a computation module 102, and a control module 103. The function modules 100-103 may provide below mentioned functions illustrated in FIG. 4.

FIG. 4 is a flowchart of one embodiment of a method of compensating center position of mechanical arms. Depending on the embodiment, additional blocks may be added, others removed, and the ordering of the blocks may be changed.

In block S10, the selection module 100 selects a first test point and a second test point on the electronic product 24 according to commands input by a user via an interface (not shown) of the center position compensation system 10 using the input device 13, and acquires coordinates of the first test point and the second test point. In one embodiment, the first test point and the second test point may be two ends of an electronic component of the electronic product 24.

In block S11, the receiving module 101 receives a distance R. The distance R is between the first probe 21 and the center position of the mechanical arm 20 on the measuring machine 2. In another embodiment, the distance R may be between the second probe 22 and the center position of the mechanical arm 20. In one example, distance R can be input by the user via the interface of the center position compensation system 10 using the input device 13.

In block S12, the computation module 102 computes an angle θ between the platform 23 and a line formed according to the coordinates of the first test point and the second test point. In one embodiment, the computation module 102 firstly computes a value of the formula:

$$tan θ = \frac{Y 2 - Y 1}{X 2 - X 1} ,$$

where (X1, Y1) are the coordinates of the first test point, and (X2, Y2) are the coordinates of the second test point. The computation module 102 computes the angle θ according to the value of tan θ.

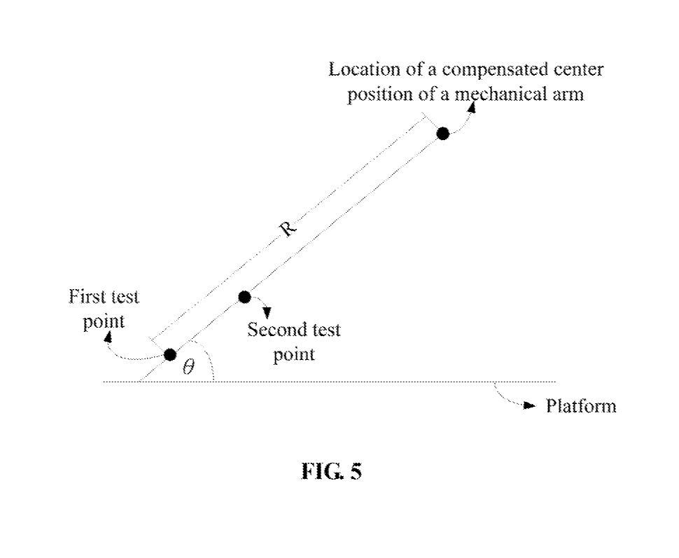

In block S13, the computation module 102 further computes coordinates of a compensated center position of the mechanical arm 20 according to the distance R, the angle θ, and the coordinates of the first test point. When the first probe 21 measures the first test point and the second probe 22 measures the second test point, the first probe 21 should be positioned at the first test point and the second probe 22 should be positioned at the second test point, thus, the distance between the first test point and the location of the compensated center position of the mechanical arm 20 is R too, as shown in FIG. 5. In one embodiment, the computation module 102 computes the coordinates (Xn, Yn) of the compensated center position of the mechanical arm 20 using the formulas Xn=R*cos θ, Yn=R*sin θ, where (X1, Y1) are the coordinates of the first test point. In another embodiment, if the distance R is between the second probe 22 and the center position of the mechanical arm 20, the computation module 102 computes coordinates of a compensated center position of the mechanical arm 20 according to the distance R, the angle θ, and the coordinates of the second test point.

In block S14, the control module 103 controls the mechanical arm 20 to move to the location of the compensated center, and thus locating the first probe 21 and the second probe 22 respectively at the first test point and the second test point.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computerized method of a measuring machine for compensating the center position of a mechanical arm of the measuring machine, the method comprising:
selecting a first test point and a second test point on an electronic product that is placed on a platform of the measuring machine, the measuring machine further comprising a first probe and a second probe, the first probe and the second probe being positioned on one end of the mechanical arm;
acquiring coordinates of the first test point and the second test point;
receiving a distance R between the first probe and the center position of the mechanical arm or between the second probe and the center position of the mechanical arm;
computing an angle θ between the platform and a line formed according to the coordinates of the first test point and the second test point;
computing coordinates of a compensated center position of the mechanical arm according to the distance R, the angle θ, and the coordinates of the first test point or the coordinates of the second test point; and
controlling the mechanical arm to move to the location of the compensated center, and thus locating the first probe and the second probe respectively at the first test point and the second test point.

2. The method according to claim 1, wherein the first test point and the second test point are two ends of an electronic component of the electronic product.

3. A non-transitory storage medium having stored thereon instructions that, when executed by a processor of a computing device, causes the processor to perform a method of compensating center position of a mechanical arm of a measuring machine, the method comprising:
selecting a first test point and a second test point on an electronic product that is placed on a platform of the measuring machine, the measuring machine further comprising a first probe and a second probe, the first probe and the second probe being positioned on one end of the mechanical arm;
acquiring coordinates of the first test point and the second test point;
receiving a distance R between the first probe and the center position of the mechanical arm or between the second probe and the center position of the mechanical arm;
computing an angle θ between the platform and a line formed according to the coordinates of the first test point and the second test point;
computing coordinates of a compensated center position of the mechanical arm according to the distance R, the angle θ, and the coordinates of the first test point or the coordinates of the second test point; and
controlling the mechanical arm to move to the location of the compensated center, and thus locating the first probe and the second probe respectively at the first test point and the second test point.

4. The non-transitory storage medium according to claim 3, wherein the first test point and the second test point are two ends of an electronic component of the electronic product.

5. A computing device, comprising:
a non-transitory storage medium;
at least one processor; and
one or more modules that are stored in the non-transitory storage medium; and are executed by the at least one processor, the one or more modules comprising instructions to:
select a first test point and a second test point on an electronic product that is placed on a platform of a measuring machine, the measuring machine further comprising a first probe a second probe, and a mechanical arm, the first probe and the second probe being positioned on one end of the mechanical arm;
acquire coordinates of the first test point and the second test point;
receive a distance R between the first probe and the center position of the mechanical arm or between the second probe and the center position of the mechanical arm;
compute an angle θ between the platform and a line formed according to the coordinates of the first test point and the second test point;
compute coordinates of a compensated center position of the mechanical arm according to the distance R, the angle θ, and the coordinates of the first test point or the coordinates of the second test point; and
control the mechanical arm move to the location of the compensated center, thus, locating the first probe and the second probe respectively at the first test point and the second test point.

6. The computing device according to claim 5, wherein the first test point and the second test point are two ends of an electronic component of the electronic product.
